(19) United States
(12) Patent Application Publication
(10) Pub. No.: US 2008/0090126 A1
(43) Pub. Date: Apr. 17, 2008

(54) Preservation Method Of Polymer Electrolyte Membrane Electrode Assembly Technical Field

(76) Inventors: Shigeyuki Unoki, Osaka (JP); Eiichi Yasumoto, Kyoto (JP); Shinsuke Takeguchi, Osaka (JP); Yoichiro Tsuji, Osaka (JP)

Correspondence Address: MCDERMOTT WILL & EMERY LLP, 600 13TH STREET, NW, WASHINGTON, DC, 20005-3096, US

(21) Appl. No.: 11/664,532

(22) PCT Filed: Sep. 16, 2005
(86) PCT No.: PCT/JP05/17110

§ 371 Date: Apr. 3, 2007

(30) Foreign Application Priority Data
Oct. 5, 2004 (JP) 2004-293030

(51) Int. Cl. H01M 8/10

(52) U.S. Cl. 429/30

(57) ABSTRACT

A preservation method of a polymer electrolyte membrane electrode assembly (MEA) which is capable of controlling its degradation that may be thereafter caused by the preservation is provided. A method of preserving a polymer electrolyte membrane electrode assembly including a polymer electrolyte membrane, a pair of catalyst layers disposed on both surfaces of the polymer electrolyte membrane, and a pair of gas diffusion electrodes disposed on outer surfaces of the pair of the catalyst layers, the method comprising the steps of causing the polymer electrolyte membrane electrode assembly to perform a power generation process just after the polymer electrolyte membrane electrode assembly is manufactured or within a time period in which degradation of the polymer electrolyte membrane electrode assembly due to influence of a solvent or impurities does not occur (step S1); and thereafter preserving the polymer electrolyte membrane electrode assembly (step S2).

### TECHNICAL FIELD

The present invention relates to a method of preserving a hydrogen ion electrically-conductive polymer electrolyte electrode assembly. The present invention relates to a method of preserving a polymer electrolyte membrane electrode assembly for polymer electrolyte fuel cell which is for use with, for example, home cogeneration systems, two-wheeled motor vehicles, electric vehicles, hybrid electric vehicles, home electric appliances, portable electric devices such as portable computers, cellular phones, portable acoustic instruments, personal digital assistances, etc.

### BACKGROUND ART

A polymer electrolyte fuel cell (hereinafter simply referred to as a fuel cell) using a hydrogen ion electrically-conductive polymer electrolyte generates electric power and heat by electrochemically reacting a fuel gas containing hydrogen and an oxidizing gas such as air containing oxygen.

FIG. 1 is a view schematically showing a polymer electrolyte membrane electrode assembly (MEA: Membrane-Electrode Assembly). A MEA 10 is a basic part of the polymer electrolyte fuel cell, and includes a polymer electrolyte membrane 11 that selectively transports hydrogen ions, and a pair of electrodes (anode electrode 14a and cathode electrode 14c) disposed on both surfaces of the polymer electrolyte membrane 11.

The electrodes 14a and 14b include catalyst layers 12 mainly containing electrically-conductive carbon powder carrying platinum based metal catalyst, and gas diffusion electrodes 13 which are provided outside the catalyst layers 12 and are formed by water-repellent carbon papers having air-permeability and electron conductivity.

Typically, a plurality of MEAs 10 are stacked to form the fuel cell.

FIG. 2 is a view schematically showing a stacked layer portion of the MEA, forming the fuel cell. In FIG. 2, the same reference symbols are used to identify the same components as those of FIG. 1.

In order to inhibit leakage of gases supplied to the fuel cell outside the fuel cell or mixing of the fuel gas and the oxidizing gas, gas seal materials and MEA gaskets 15 are disposed at the peripheries of the electrodes 14a and 14c with the hydrogen ion electrically-conductive polymer electrolyte membranes 11 interposed therebetween. In addition, electrically-conductive separator plates 16 are disposed outside the MEA 10 to mechanically fasten the MEA 10 and to electrically connect adjacent MEAs 10 to each other. Gas passages 18a and 18c are formed at regions of the separator plates 16 which are in contact with the MEA 10 to supply reaction gases to electrode surfaces and to carry generated gases or excess gases away. The gas passages 18a and 18c may be provided separately from the separator plates 16, but grooves are typically formed on the surfaces of the separator plates 16 to form the gas passages. Between adjacent two separators 16, a cooling water passage 19 and a separator gasket 20 are provided.

The plurality of MEAs 10 and separate plates 16 which are thus stacked are sandwiched between end plates with current collecting plates and insulating plates interposed between the end plates and the separate plates 16, and are fastened from opposite end sides by fastener bolts, thus forming a general structure of the fuel cell.

By filling water in the polymer electrolyte membrane 11 in saturated state, a specific resistance of the membrane 11 becomes small and thus the membrane 11 functions as the hydrogen ion electrically-conductive electrolyte. For this reason, during operation of the fuel cell, the fuel gas and the oxidizing gas are supplied in a humidified state to prevent vaporization of the water from the polymer electrolyte membrane 11. During power generation process, water is generated as a reaction product on cathode side through electrochemical reactions represented by the following formulae (1) and (2).
Anode reaction: H₂→2H⁺+2e⁻ (1)
Cathode reaction: 2H⁺+(½)O₂+2e⁻→H₂O (2)

The water in the humidified fuel gas, the water in the humidified oxidizing gas, and the water generated through the reaction are used to keep the polymer electrolyte membrane 11 in the saturated state, and are further discharged outside the fuel cell along with the excess fuel gas and the excess oxidizing gas.

The MEA 10 is typically integrated as shown in FIG. 1 to achieve good proton transmissivity at an interface between the polymer electrolyte membrane 11 and the anode catalyst layer 12 and the cathode catalyst layer 12, and to achieve good electron transmissivity at an interface between the catalyst layer 12 and the gas diffusion electrode 13.

The MEA 10 is typically integrated in such a way that the polymer electrolyte membrane 11 is sandwiched between the catalyst layers 12 in contact with the anode and cathode gas diffusion layers 13 and the polymer electrolyte membrane 11, and are heated and pressurized, or the polymer electrolyte membrane 11 provided with the catalyst layers 12 on both surfaces are sandwiched between the two gas diffusion electrodes 13 and are heated and pressurized.

However, in the MEA 10 manufactured in these methods, the polymer electrolyte membrane 11 is likely to be damaged, and membrane strength or ion exchangeability is likely to be degraded if a heating temperature or pressure is increased for the purpose of gaining a satisfactory joined state during the manufacture by integration. Furthermore, since the high pressure during the manufacture by integration promotes consolidation of the catalyst layers 12 and the gas diffusion electrodes 13 and thereby the gas diffusability decreases, the polymer electrolyte membrane 11 and the catalyst layer 12 cannot be joined to each other sufficiently.

As a result, there exist problems that ion resistance at the interface between the polymer electrolyte membrane 11 and the catalyst layer 12 becomes higher, and electron resistance at the interface between the catalyst layer 12 and the gas diffusion electrode 13 becomes higher because of insufficient jointed state of the catalyst layer 12 and the gas diffusion electrode 13.

As a solution to such problems, there has been disclosed a method in which a structure in which a polymer electrolyte membrane is sandwiched between two electrodes is heated, pressurized, and integrated, in a solvent (e.g., see Japanese Laid-Open Patent Application Publication No. Hei. 3-208265). In this method, since the polymer electrolyte membrane is softened in the solvent or a part of it is dissolved and swollen in the solvent, the polymer electrolyte membrane is easily joined to the gas diffusion electrode. In addition, in this case, the polymer electrolyte membrane easily enters a reaction membrane of the gas diffusion electrode, an area where a catalytic reaction occurs increases. Furthermore, since the polymer electrolyte membrane are extremely thinned as a result, resistance of ion conductivity decreases.

However, it was confirmed that in this method, since the polymer electrolyte membrane is swollen after being integrated, the polymer electrolyte membrane and the catalyst layer are likely to peel off from each other at the interface, degrading the joined state at the interface.

To improve such a situation, there has been proposed a method in which a polymer electrolyte membrane and/or catalyst layer including the solvent is heated and pressurized substantially without being immersed in the solvent (see e.g., Japanese Laid-Open Patent Application Publication No. 2002-93424). In this method, since the solvent in the MEA is vaporized during integration, the problem occurring when the structure is integrated in the solvent has been resolved, and good joined state at the interface between the polymer electrolyte membrane and the catalyst layer is maintained.

### DISCLOSURE OF THE INVENTION

### Problems to be Solved by the Invention

When the MEA integrated by the method disclosed in Japanese Laid-Open Patent Application Publication No. 2002-93424 is compared to the MEA integrated by the method disclosed in Japanese Laid-Open Patent Application Publication No. 3-208262, it has been found that there is no substantial solvent remaining in the polymer electrolyte membrane but the solvent in the polymer electrolyte membrane that has ingressed into catalyst layer pores cannot be sufficiently vaporized. In a case where after the MEA is preserved for a long time period, the MEA is incorporated into the fuel cell and the fuel cell is operated, the solvent remaining in the catalyst layer causes problems such as degradation of the joined state at interface between the polymer electrolyte membrane and the catalyst layer and poisoning of the catalyst. For this reason, in that case, voltage drop becomes significant during continued operation, as compared to the case where just after the MEA is manufactured by integration, the MEA is incorporated into the fuel cell and the fuel cell is operated.

In cases where the MEA is integrated by methods other than the method disclosed in Japanese Laid-Open Patent Application Publication, impurities (especially metal impurities) invaded into the MEA during the manufacture No. 2002-93424, may cause problems such as degradation of the polymer electrolyte membrane during long time preservation of the MEA. For this reason, in the case where the MEA is preserved for a long time period, and then is operated as the fuel cell, the voltage drop becomes significant during continued operation as compared to the case where the MEA is integrated and immediately thereafter is operated as the fuel cell.

The present invention is aimed at solving the problems associated with the above mentioned prior arts, and an object of the present invention is to provide a preservation method of a polymer electrolyte membrane electrode assembly (MEA) that is capable of controlling voltage drop associated with preservation of the polymer electrolyte membrane electrode assembly, to be specific, voltage drop occurring during continued operation of the fuel cell.

### Means for Solving the Problems

To achieve the above described object, according to a first invention of the present invention, there is provided a method of preserving a polymer electrolyte membrane electrode assembly including a polymer electrolyte membrane, a pair of catalyst layers disposed on both surfaces of the polymer electrolyte membrane, and a pair of gas diffusion electrodes disposed on outer surfaces of the pair of the catalyst layers, the method comprising the steps of: causing the polymer electrolyte membrane electrode assembly to perform a power generation process just after the polymer electrolyte membrane electrode assembly is manufactured or within a time period in which the polymer electrolyte membrane electrode assembly is not degraded; and thereafter preserving the polymer electrolyte membrane electrode assembly. In such a configuration, the degradation of the polymer electrolyte membrane electrode assembly (MEA) which may be caused by the preservation can be controlled, to be specific, the voltage drop of the fuel cell during the continued operation can be controlled. As used herein, the time period in which the MEA is not degraded refers to a time period in which the polymer electrolyte membrane electrode assembly is not used yet and the effects of controlling the degradation are confirmed in the preservation time period after the step of causing the polymer electrolyte membrane electrode assembly to perform the power generation process.

According to a second invention, in the method of preserving a polymer electrolyte membrane electrode assembly of the first invention, a current density in the power generation process may be not less than 0.1 A/cm² and not more than 0.4 A/cm² per area of the catalyst layers. In such a configuration, the degradation of the polymer electrolyte membrane electrode membrane assembly (MEA) which may be caused by the preservation can be controlled more effectively.

According to a third invention, in the method of preserving a polymer electrolyte membrane electrode assembly of the first invention, the polymer electrolyte membrane electrode assembly may be caused to perform the power generation process for 3 hours or more. In such a configuration, the degradation of the polymer electrolyte membrane electrode assembly (MEA) which may be caused by the preservation can be controlled more effectively.

According to a fourth invention, in the method of preserving a polymer electrolyte membrane electrode assembly of the first invention, the polymer electrolyte membrane electrode assembly may be caused to perform the power generation process until a voltage change per unit time becomes 2 mV/h or less. In such a configuration, the degradation of the polymer electrolyte membrane electrode assembly (MEA) which may be caused by the preservation can be controlled more effectively.

According to a fifth invention, in the method of preserving a polymer electrolyte membrane electrode assembly of the first invention, the polymer electrolyte membrane electrode assembly may be caused to perform the power generation process within 300 hours after the polymer electrolyte membrane electrode assembly is manufactured. In such a configuration, the degradation of the polymer electrolyte membrane electrode assembly (MEA) which may be caused by the preservation can be controlled more effectively.

According to sixth invention, in the method of preserving a polymer electrolyte membrane electrode assembly, the polymer electrolyte membrane electrode assembly may be caused to perform the power generation process while supplying a fuel gas and an oxidizing gas which have dew points within a range of not lower than −10° C. and not higher than +10° C. of a temperature of the polymer electrolyte membrane electrode assembly. In such a configuration, the degradation of the polymer electrolyte membrane electrode assembly (MEA) which may be caused by the preservation can be controlled more effectively.

### EFFECTS OF THE INVENTION

The present invention can provide a preservation method of the polymer electrolyte membrane electrode assembly (MEA) which is capable of controlling degradation of the MEA which may be caused by the preservation.

### BRIEF DESCRIPTION OF THE DRAWINGS

FIG. 1 is a view schematically showing a construction of a polymer electrolyte membrane electrode assembly (MEA);

FIG. 2 is a view schematically showing a layered portion of the MEA forming a fuel cell; and

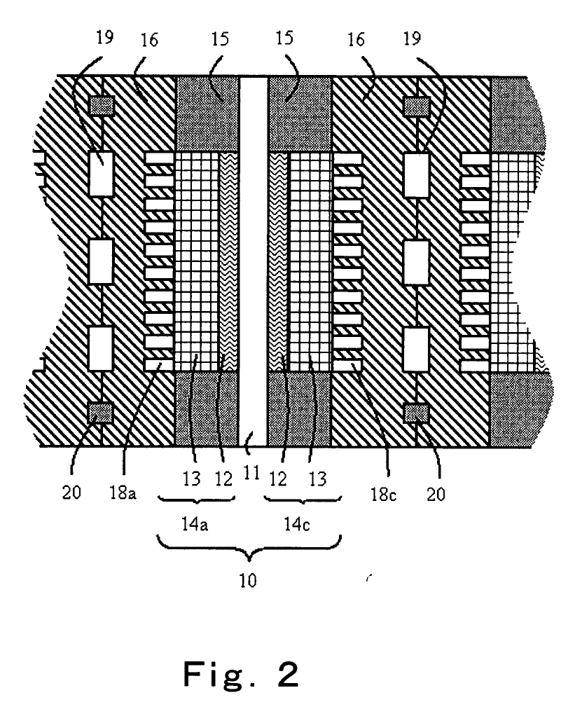

FIG. 3 is a flowchart showing a preservation method of the polymer electrolyte membrane electrode assembly of a first embodiment of the present invention.

### EXPLANATION OF REFERENCE NUMERALS

10 polymer electrolyte membrane electrode assembly (MEA)

11 polymer electrolyte membrane

12 catalyst layer

13 gas diffusion electrode

14a anode electrode

14c cathode electrode

15 MEA gasket

16 separator plate

17 MEA

18a, 18c gas passage

19 cooling water passage

20 separator gasket

### BEST MODE FOR CARRYING OUT THE INVENTION

Hereinafter, embodiments of the present invention will be described.

### Embodiment 1

A preservation method of a polymer electrolyte membrane electrode assembly according to a first embodiment of the present invention will be described.

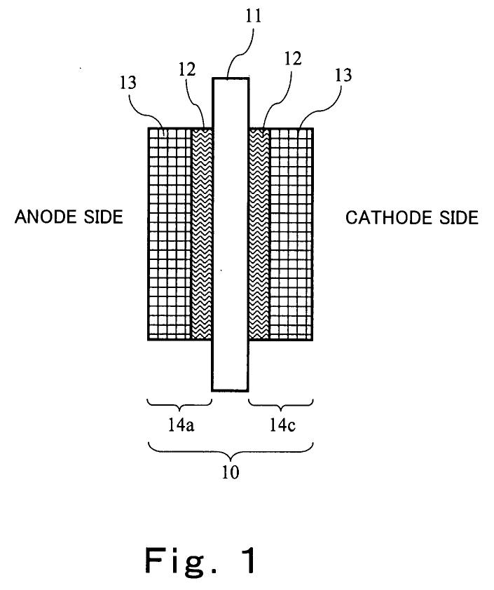

The preservation method of the polymer electrolyte membrane electrode assembly of the first embodiment has features that a MEA 10 shown in FIG. 1 is manufactured by integration, and thereafter is caused to perform power generation process before it is preserved for a long time period. The MEA 10 may be manufactured by integration by any methods.

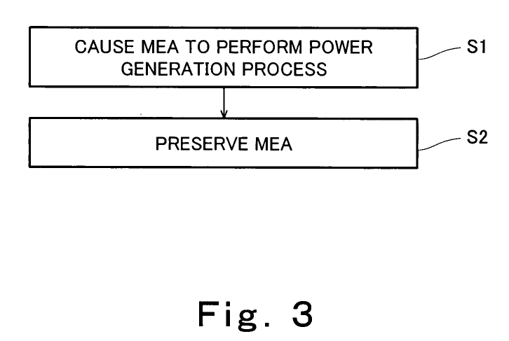

FIG. 3 is a flowchart showing a preservation method of the polymer electrolyte membrane electrode assembly of a first embodiment of the present invention. As shown in FIG. 3, first, the MEA 10 manufactured by integration is caused to perform power generation process before it is preserved for a long time period (step S1). In this embodiment, the MEA 10 is incorporated into the fuel cell. To be specific, the MEA 10 is sandwiched between an anode electrically-conductive separator plate 16 and a cathode electrically-conductive separator plate 16. End plates are superposed on both ends of the two separator plates 16 with current collecting plate and insulating plates interposed between the end plates and the separator plates 16, and are fastened by fastener bolts, thereby forming the fuel cell.

Then, a power load is connected to the fuel cell. A fuel gas is supplied to anode side of the MEA 10 and an oxidizing gas is supplied to cathode side of the MEA 10 to cause the fuel cell to perform power generation process. After the fuel cell is caused to perform the power generation process with a predetermined current density for a predetermined time, the power generation process is stopped.

Then, the MEA 10 is preserved (step 2). In this embodiment, after the power generation process is stopped, the MEA 10 is detached from the fuel cell and preserved. Alternatively, the MEA 101 may be preserved as being incorporated into the fuel cell.

Whereas in the first embodiment, the MEA 10 is incorporated into a stack to form the fuel cell and the fuel cell is caused to perform the power generation process, it is not always necessary to form the fuel cell so long as the MEA is caused to perform the power generation process. For example, the MEA 10 may be caused to perform the power generation process using a power generation tester used in performance test or the like of the MEA 10.

As described above, the preservation method of the polymer electrolyte membrane electrode assembly of the first embodiment has features that before preservation, the fuel gas and the oxidizing gas are supplied to the anode side of the MEA 10 and to the cathode side of the MEA 10, respectively, and a power is output to the power load, i.e., power generation process is performed.

In the preservation method of the polymer electrolyte membrane electrode assembly of the first embodiment, the MEA 10 is caused to perform the power generation process before being preserved, and thereby degradation that may be thereafter caused by the preservation can be controlled effectively. This may be due to the fact that solvent in the catalyst pores which remain unvaporized in a polymer electrolyte membrane and electrode integration process, and the impurities such as metal invaded into the MEA 10 during the manufacture of the MEA 10 can be discharged outside the MEA 10 together with the water generated in the power generation process.

In addition, by setting a predetermined current density in the power generation process before the preservation of the MEA 10 to not less than 0.1 A/cm² and not more than 0.4 A/cm² per area of the catalyst layer, the degradation that may be thereafter caused by the preservation can be controlled effectively. This may be due to the fact that an electrochemical reaction in the MEA 10 can be made to uniformly occur so as to uniformly generate water through the reaction between the fuel gas and the oxidizing gas, and thereby the solvent in the catalyst pores or the like which remain unvaporized during the polymer electrolyte membrane and electrode integration process, and the impurities such as metal invaded into the MEA 10 during the manufacture of the MEA 10 can be discharged outside the MEA 10 together with the water generated in the power generation process.

By setting a predetermined time in the power generation process before the MEA 10 is preserved to 3 hours or more, the degradation that may be thereafter caused by the preservation can be controlled more effectively. This may be due to the fact that, in a sufficient power generation time, the solvent in the catalyst pores or the like which remain unvaporized during the polymer electrolyte membrane and electrode integration process, and the impurities such as metal invaded into the MEA 10 during the manufacture of the MEA can be discharged outside the MEA 10 together with the water generated in the power generation process.

In the power generation process before the MEA 10 is preserved, by causing the MEA 10 to perform the power generation process until a voltage change (dV/dt) of the MEA 10 per unit time to 2 mV/h or less, the degradation that may be thereafter caused by the preservation can be controlled more effectively. This may be due to the fact that, through an electrochemical reaction occurring in a sufficient period, the solvent in the catalyst pores or the like which remain unvaporized during the polymer electrolyte membrane and electrode integration process, and the impurities such as metal invaded into the MEA 10 during the manufacture of the MEA 10 can be discharged outside the MEA 10 together with the water generated in the power generation process.

By causing the MEA 10 to perform the power generation process before the MEA 10 is preserved, within a time period in which the MEA 10 is not degraded, after the MEA 10 is manufactured by integration, the degradation that may be thereafter caused by the preservation can be controlled more effectively. This may be due to the fact that, before progress of the degradation of the MEA 10 which may be caused by the solvent in the catalyst pores or the like which remain unvaporized during the polymer electrolyte membrane and electrode integration process, and the impurities such as metal invaded into the MEA 10 during the manufacture of the MEA 10, the solvent and the impurities can be discharged outside the MEA 10 together with the water generated in the power generation process. As used herein, the time period in which the MEA 10 is not degraded refers to a time period in which the MEA 10 is not used yet and the effects of controlling the degradation are confirmed in the preservation time period after the power generation process. For example, the time period can be found by an operation test in the examples illustrated below. One example of this is a time period within 300 hours after the MEA 10 is manufactured by integration.

In the power generation process before the MEA 10 is preserved, by setting dew points of the fuel gas and the oxidizing gas which are to be supplied within a range of not lower than −10° C. and not higher than +10° C. of the temperature of the MEA 10, the degradation that may be thereafter caused by the preservation can be controlled more effectively. This may be due to the fact that water is supplied to the MEA 10 sufficiently but not excessively, and non-uniform electrochemical reaction due to the clogging of the gas passages with the discharged water does not occur, so that the water is generated uniformly through the reaction between the fuel gas and the oxidizing gas within the MEA 10. Thereby, the solvent in the catalyst pores or the like which remain unvaporized during the polymer electrolyte membrane and electrode integration process, and the impurities such as metal invaded into the MEA 10 during the manufacture of the MEA 10 can be discharged outside the MEA 10 together with the water generated in the power generation process.

### EXAMPLES

Hereinafter, the present invention will be described based on examples below. The present invention is not intended to be limited to these examples.

First of all, a MEA manufacturing method that is common to the fuel cells in examples and comparative examples will be described.

In manufacturing the MEA 10, a polymer electrolyte membrane-catalyst layer assembly was manufactured with a method described below.

10 g of catalyst powder, 35 g of water, 59 g of alcohol dispersion of perfluorosulfonic acid ion exchange resin (Product name: 9% FFS produced by Asahi Glass Co. Ltd) were mixed using a ultrasolic agitator to produce a catalyst layer paste. As the catalyst power, powder having a structure platinum is carried in weight ratio of 50:50 on ketjenblack EC (KETJENBLACK EC) with a specific surface area of 800 m²/g and a DBP oil absorption of 360 m 1/100 g was used.

The catalyst layer paste was applied onto a polypropylene support film (Torayfan(registered mark) 50-2500 produced by Toray Industries Inc) with a film thickness of 50 μm using a coating machine (M200L manufactured by HIRANO TECSEED Co. Ltd) and was dried to form the catalyst layer 12. The size of the catalyst layer 12 was 6×6 cm².

Next, two catalyst layers 12 formed on the polypropylene support films sandwiched both surfaces of the polymer electrolyte membrane 11 with a size of 12×12 cm² (Gore-Select(registered mark) produced by JAPAN GORE-TEX INC) in such a way that the surface on the catalyst layer side is located on the polymer electrolyte membrane side. Then, this structure was roll-pressed and then only the polypropylene support films were peeled off from both surfaces, creating the polymer electrolyte membrane 11 attached with the catalyst layers 12 on both surfaces thereof. The amount of platinum in the catalyst layer 12 thus produced was 0.3 mg/cm² per surface.

Then, the polymer electrolyte membrane 11 attached with the catalyst layers 12 on the both surfaces were boiled for 30 minutes in pure water to contain water, and thereafter was preserved in pure water with room temperature, keeping the membrane 11 in water-containing state.

Then, the both surfaces of the polymer electrolyte membrane 11 containing water and attached with the catalyst layers 12 on the both surfaces thereof were sandwiched between two gas diffusion layers 13 (Carbel-CL (registered mark) produced by JAPAN GORE-TEX INC.), one surfaces of which were applied with bonding agent produced by diluting dispersion of perfluorosulfonic acid ion exchange resin (Product name: 9% FFS produced by Asahi Glass Co. Ltd), by a spray method. This structure was hot-pressed at a temperature of 100° C., for 60 minutes, and with a pressure of 50×10⁵ Pa, thus manufacturing the polymer electrolyte membrane electrode assembly (MEA) 10. The size of the gas diffusion layers 13 was 6.2×6.2 cm².

The manufactured MEA 10 was sandwiched between the anode electrically-conductive separator 16 and the cathode electrically-conductive separator 16 each of which has a size of 120 mm square and a thickness of 5 mm. The end plates were superposed on both ends of the separators 16 with the current collecting plates and the insulating plates interposed between the end plates and the separator plates 16 and were fastened by fastener bolts with a fastening force of 14 kN, manufacturing the fuel cell.

The fuel cell was kept at a temperature of 70° C. and was supplied with increased in temperature and humidified hydrogen gas and air, and a fuel utilization ratio was set to 70% and an oxidizing gas utilization ratio was set to 40%.

In each example and comparative example, after the MEA 10 was caused to perform power generation process, it was preserved under room temperature and normal humidity for 8 weeks. The preservation period of 8 weeks is one example of the period in which the polymer electrolyte membrane 11 is degraded due to the influence of the solvent or the impurities in the present invention. In the examples described below, this period is expressed as a long time preservation period so as to be distinct from the preservation period before the MEA 10 is caused to perform the power generation process.

### Example 1

After the manufacture of the MEA 10, the fuel cell was manufactured using the MEA 10 preserved under room temperature and normal humidity for 1 week. The fuel cell was caused to perform power generation process for 3 hours with a current density of 0.4 A/cm² in such a way that hydrogen gas and air humidified to have a dew point of 70° C. were increased in temperature up to 70° C. and were supplied to the fuel cell while keeping the temperature of the fuel cell at 70° C. After the power generation process, the MEA 10 was preserved as being incorporated into this fuel cell under room temperature and normal humidity for 8 weeks.

### Example 2

After the manufacture of the MEA 10, the fuel cell was manufactured using the MEA 10 preserved under room temperature and normal humidity for 1 week. The fuel cell was caused to perform power generation process for 3 hours with a current density of 0.4 A/cm² in such a way that hydrogen gas and air humidified to have a dew point of 70° C. were increased in temperature up to 70° C. and were supplied to the fuel cell while keeping the temperature of the fuel cell at 70° C. After the power generation process, the MEA 10 was detached from this fuel cell and was preserved under room temperature and normal humidity for 8 weeks.

### Comparative Example 1

After the manufacture of the MEA 10, the fuel cell was manufactured using the MEA 10 preserved under room temperature and normal humidity for 1 week. The MEA 10 was preserved as being incorporated in this fuel cell without the gas supply and the power generation process under room temperature and normal humidity for 8 weeks.

In the fuel cells in the example 1 and the comparative example 1, and in the fuel cell in the example 2 manufactured once again, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were increased in temperature up to 70° C. and were supplied to the anode and the cathode, respectively while keeping the temperature of the fuel cells at 70° C.

Table 1 shows voltage drop amount ΔV of the MEA 10 in each of the example 1, the example 2, and the comparative example 1 in operation test.

TABLE 1

| | Δ V (mV) |
|---|---|
| Example 1 | 10 |
| Example 2 | 8 |
| Comparative example 3 | 100 |

The table 1 clearly shows that the voltage drop amount ΔV is smaller in the example 1 and example 2 than in the comparative example 1.

From this result, it was confirmed that, by causing the fuel cell to perform the power generation process before the MEA 10 is preserved for a long time period, degradation that may be thereafter caused by the preservation can be controlled effectively.

In addition, from comparison between the example 1 and the example 2, it was confirmed that the degradation which may be thereafter caused by the preservation was able to be controlled effectively in the same manner both in the MEA 10 incorporated in the fuel cell or the MEA 10 detached from the fuel cell that has performed the power generation process, before the MEA 10 is preserved for a long time period.

### Comparative Example 2

After the manufacture of the MEA 10, the fuel cell was manufactured using the MEA 10 preserved under room temperature and normal humidity for 1 week. The fuel cell was caused not to perform power generation process under the condition in which hydrogen gas and air that were humidified to have a dew point of 70° C. and increased in temperature up to 70° C., were supplied to the fuel cell for 3 hours while keeping the temperature of the fuel cell at 70° C. After the supply, the MEA 10 was preserved as being incorporated in this fuel cell under room temperature and normal humidity for 8 weeks.

In the fuel cell of the comparative example 2, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were increased in temperature up to 70° C. and were supplied to the fuel cell while keeping the temperature of the fuel cell at 70° C.

Table 2 shows voltage drop amount ΔV of the MEA 10 in each of the example 1 and the comparative example 2 in the operation test.

TABLE 2

| | Δ V (mV) |
|---|---|
| Example 1 | 10 |
| Comparative example 2 | 90 |

The table 2 clearly shows that the voltage drop amount ΔV is smaller in the example 1 than in the comparative example 2. From this result, not only by the supply of the increased in temperature and humidified gases before the MEA 10 is preserved for a long time period but also by causing the MEA to perform the power generation process, the degradation that may be caused by the preservation can be controlled effectively.

### Example 3

After the manufacture of the MEA 10, the fuel cell was manufactured using the MEA 10 preserved under room temperature and normal humidity for 1 week. The fuel cell was caused to perform power generation process for 12 hours with a current density of 0.1 A/cm² in such a way that hydrogen gas and air humidified to have a dew point of 70° C. were increased in temperature up to 70° C. and were supplied to the fuel cell while keeping the temperature of the fuel cell at 70° C. After the power generation process, the MEA 10 was preserved as being incorporated into this fuel cell under room temperature and normal humidity for 8 weeks.

### Comparative Example 3

After the manufacture of the MEA 10, the fuel cell was manufactured using the MEA 10 preserved under room temperature and normal humidity for 1 week. The fuel cell was caused to perform power generation process for 12 hours with a current density of 0.05 A/cm² in such a way that hydrogen gas and air humidified to have a dew point of 70° C. were increased in temperature up to 70° C. and were supplied to the fuel cell while keeping the temperature of the fuel cell at 70° C. After the power generation process, the MEA 10 was preserved as being incorporated into this fuel cell under room temperature and normal humidity for 8 weeks.

### Comparison Example 4

After the manufacture of the MEA 10, the fuel cell was manufactured using the MEA 10 preserved under room temperature and normal humidity for 1 week. The fuel cell was caused to perform power generation process for 3 hours with a current density of 0.5 A/cm² in such a way that hydrogen gas and air humidified to have a dew point of 70° C. were increased in temperature up to 70° C. and were supplied to the fuel cell while keeping the temperature of the fuel cell at 70° C. After the power generation process, the MEA 10 was preserved as being incorporated into this fuel cell under room temperature and normal humidity for 8 weeks.

In the fuel cells in the example 3 and the comparative examples 3 and 4, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were increased in temperature up to 70° C. and were supplied to the respective fuel cells while keeping the temperature of the fuel cell at 70° C.

Table 3 shows the current density I per area of the catalyst layer 12 in the power generation process, voltage change (dV/dt) of the MEA 10 per time at the end of the power generation process, and the voltage drop amount ΔV of the MEA 10 in the operation test in each of the example 1, the example 3, the comparative example 3, and the comparative example 4.

TABLE 3

| | I(A/cm²) | dV/dt (mV/h) | Δ V (mV) |
|---|---|---|---|
| Example 1 | 0.4 | 1.5 | 10 |
| Example 3 | 0.1 | 0.0 | 8 |
| Comparative example 3 | 0.05 | 5.0 | 50 |
| Comparative example 4 | 0.5 | 3.0 | 70 |

The table 3 clearly shows that the voltage drop amount ΔV is smaller in the examples 1 and 3 than in the comparative examples 3 and 4. It may be therefore assumed that when the current density I is outside the range of 0.1 A/cm² to 0.4 A/cm², the electrochemical reaction within an electrode surface becomes non-uniform and thus the impurities in the pores within the catalyst layers cannot be discharged sufficiently outside the 10 MEA together with the water generated in the power generation process. From this result, it was confirmed that by setting the current density in the power generation process performed before the MEA 10 is preserved for a long time period to not less than 0.1 A/cm² and not more than 0.4 A/cm², the degradation that may be thereafter caused by the preservation can be controlled more effectively.

Further, as can be clearly seen from the table 3, the voltage change dV/dt at the end of the power generation process is smaller in the example 1 and the example 3 than in the comparative example 3 and the comparative example 4. The voltage change may be assumed to occur because the impurities in the pores within the catalyst layers are being discharged outside the MEA 10 together with the water generated in the power generation process. It may be therefore assumed that the impurities in the pores within the catalyst layers has been sufficiently discharged outside the MEA 10 together with the water generated in the power generation process if the voltage change dV/dt at the end of the power generation process is 1.5 mV/h or less.

### Comparative Example 5

After the manufacture of the MEA 10, the fuel cell was manufactured using the MEA 10 preserved under room temperature and normal humidity for 15 hours, i.e., about one week. The fuel cell was caused to perform power generation process for 2 hours with a current density of 0.4 A/cm² in such a way that hydrogen gas and air increased in temperature up to a dew point of 70° C. were supplied to the fuel cell while keeping the temperature of the fuel cell at 70° C. After the power generation process, the MEA 10 was preserved as being incorporated into this fuel cell under room temperature and normal humidity for 8 weeks.

In the fuel cell of the comparative example 5, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were increased in temperature up to 70° C. and were supplied to the fuel cell while keeping the temperature of the fuel cell at 70° C.

Table 4 shows the voltage change dV/dt per time of the MEA 10 at the end of the power generation process and the voltage drop amount ΔV of the MEA 10 in the operation test in the example 1 and the comparative example 5.

TABLE 4

| | dV/dt (mV/h) | Δ V (mV) |
|---|---|---|
| Example 1 | 1.5 | 10 |
| Comparative Example 5 | 4.5 | 60 |

As can be clearly shown in table 4, the voltage drop amount ΔV is smaller in the example 1 than in the comparative example 5. It may be therefore assumed that the impurities in the pores within the catalyst layers 12 cannot be sufficiently discharged outside the MEA 10 together with the water generated in the power generation process if the time period for which the power generation is performed is less than 3 hours. From this result, it was confirmed that by setting the time period for which the power generation process is performed before the MEA 10 is preserved for a long time period to 3 hours or more, the degradation that may be caused by the preservation can be controlled more effectively.

Further, as can be clearly shown in table 4, the voltage change dV/dt at the end of the power generation process is smaller in the example 1 than in the comparative example 5. The voltage change may be assumed to occur because the impurities in the pores within the catalyst layer are being discharged outside the MEA together with the water generated in the power generation process. It may be therefore assumed that the impurities in the pores within the catalyst layers has been sufficiently discharged if the voltage change dV/dt at the end of the power generation process is 1.5 mV/h as in the table 3.

### Example 4

After the manufacture of the MEA 10, the fuel cell was manufactured using the MEA 10 preserved under room temperature and normal humidity for 300 hours, i.e., about 2 weeks. The fuel cell was caused to perform power generation process for 3 hours with a current density of 0.4 A/cm² in such a way that hydrogen gas and air humidified to have a dew point of 70° C. were supplied to the fuel cell while keeping the temperature of the fuel cell at 70° C. After the power generation process, the MEA 10 was preserved as being incorporated into this fuel cell under room temperature and normal humidity for 8 weeks.

### Comparative Example 6

After the manufacture of the MEA 10, the fuel cell was manufactured using the MEA 10 preserved under room temperature and normal humidity for 500 hours, i.e., about 3 weeks. The fuel cell was caused to perform power generation process for 3 hours with a current density of 0.4 A/cm² in such a way that hydrogen gas and air humidified to have a dew point of 70° C. were supplied to the fuel cell while keeping the temperature of the fuel cell at 70° C. After the power generation process, the MEA 10 was preserved as being incorporated into this fuel cell under room temperature and normal humidity for 8 weeks.

In the fuel cells in the example 4 and the comparative example 6, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were supplied to the fuel cell while keeping the temperature of the fuel cell at 70° C.

Table 5 shows voltage change dV/dt of the MEA 10 per time at the end of the power generation process, and the voltage drop amount ΔV of the MEA 10 in the operation test in each of the example 4 and the comparative example 6.

TABLE 5

| | dV/dt (mV/h) | Δ V (mV) |
|---|---|---|
| Example 4 | 2.0 | 12 |
| Comparative example 6 | 1.5 | 80 |

As can be clearly shown in the table 5, the voltage drop amount ΔV is smaller in the example 4 than in the comparative example 6. In addition, there is no substantial difference in the voltage change dV/dt at the end of the power generation process between the example 4 and the comparative example 6. From these results, it may be assumed that, if the fuel cell is not caused to perform the power generation process within 300 hours after the manufacture of the MEA 10, catalyst will be degraded due to the impurities in the pores within the catalyst layers 12, and further the joined state at the interface between the polymer electrolyte membrane and the catalyst becomes non-uniform, so that the degradation cannot be effectively controlled even if the impurities are discharged by causing the MEA 10 to perform the power generation process after the period in which the MEA 10 is not degraded. That is, it was confirmed that by causing the MEA 10 to perform the power generation process within the period in which the MEA 10 is not degraded, the degradation that may be caused by the preservation can be controlled more effectively.

In addition, it was confirmed that one example of the period in which the MEA 10 is not degraded is suitably 300 hours after the manufacture of the MEA 10.

### Example 5

After the manufacture of the MEA 10, the fuel cell was manufactured using the MEA 10 preserved under room temperature and normal humidity for 150 hours, i.e., about 1 week. The fuel cell was caused to perform power generation process for 3 hours with a current density of 0.4 A/cm² in such a way that hydrogen gas and air humidified to have a dew point of 60° C. (supply gas dew point T=60° C.) were increased in temperature up to 60° C. and were supplied to the fuel cell while keeping the temperature of the fuel cell at 70° C. After the power generation process, the MEA 10 was preserved as being incorporated into this fuel cell under room temperature and normal humidity for 8 weeks.

### Example 6

After the manufacture of the MEA 10, the fuel cell was manufactured using the MEA 10 preserved under room temperature and normal humidity for 150 hours, i.e., about 1 week. The fuel cell was caused to perform power generation process for 3 hours with a current density of 0.4 A/cm² in such a way that hydrogen gas and air humidified to have a dew point of 80° C. (supply gas dew point T=80° C.) were increased in temperature up to 80° C. and were supplied to the fuel cell while keeping the temperature of the fuel cell at 70° C. After the power generation process, the MEA 10 was preserved as being incorporated into this fuel cell under room temperature and normal humidity for 8 weeks.

### Comparative Example 7

After the manufacture of the MEA 10, the fuel cell was manufactured using the MEA 10 preserved under room temperature and normal humidity for 150 hours, i.e., about 1 week. The fuel cell was caused to perform power generation process for 3 hours with a current density of 0.4 A/cm² in such a way that hydrogen gas and air humidified to have a dew point of 50° C. (supply gas dew point T=50° C.) were increased in temperature up to 50° C. and were supplied to the fuel cell while keeping the temperature of the fuel cell at 70° C. After the power generation process, the MEA 10 was preserved as being incorporated into this fuel cell under room temperature and normal humidity for 8 weeks.

### Comparative Example 8

After the manufacture of the MEA 10, the fuel cell was manufactured using the MEA 10 preserved under room temperature and normal humidity for 150 hours, i.e., about 1 week. The fuel cell was caused to perform power generation process for 3 hours with a current density of 0.4 A/cm² in such a way that hydrogen gas and air humidified to have a dew point of 85° C. (supply gas dew point T=85° C.) were increased in temperature up to 85° C. and were supplied to the fuel cell while keeping the temperature of the fuel cell at 70° C. After the power generation process, the MEA 10 was preserved as being incorporated into this fuel cell under room temperature and normal humidity for 8 weeks.

In the fuel cells of the examples 5 and 6, and comparative examples 7 and 8, continued operation test was carried out for 1000 hours under the condition in which the fuel gas utilization ratio was 70%, the oxidizing gas utilization ratio was 40%, and the current density was 0.2 A/cm² in such a way that hydrogen gas and air humidified to have a dew point of 70° C. were increased in temperature up to 70° C. and were supplied to the fuel cell while keeping the temperature of the fuel cell at 70° C. Table 6 shows the supply gas dew points T, the voltage change dV/dt of the MEA 10 per time at the end of the power generation process, and the voltage drop amount ΔV of the MEA 10 in the operation test in the examples 5 and 6, and the comparative examples 7 and 8.

TABLE 6

| | T (° C.) | dV/dt (mV/h) | Δ V (mV) |
|---|---|---|---|
| Example 5 | 60 | 1.5 | 15 |
| Example 6 | 80 | 2.0 | 14 |
| Comparative example 7 | 50 | 3.0 | 55 |
| Comparative example 8 | 85 | 5.0 | 65 |

As can be clearly shown in table 6, the voltage drop amount ΔV is smaller in the examples 5 and 6 than in the comparative examples 7 and 8. Therefore, it may be assumed that the water is insufficiently or excessively if the dew points of the hydrogen gas and air supplied are outside the range of not lower than −10° C. and not higher than +10° C. of the temperature (70° C.) of the fuel cell, causing non-uniform electrochemical reaction to occur within the electrode surface. In this case, therefore, it may be assumed that the impurities in the pores within the catalyst layer 12 cannot be sufficiently discharged outside the MEA 10 together with the water generated in the power generation process.

From this result, it was confirmed that by setting the dew points of the supply gases in the power generation process to temperatures within the range of not lower than −10° C. and not higher than +10° C. of the temperature of the fuel cell, the degradation that may be thereafter caused by the preservation can be controlled more effectively.

Furthermore, as can be clearly seen from the table 6, the voltage change dV/dt at the end of the power generation process is smaller in the examples 5 and 6 than in the comparative examples 7 and 8. The voltage change may be assumed to occur because the impurities in the pores within the catalyst layers 12 are being discharged outside the MEA together with the water generated in the power generation process. Therefore, by the analysis from the results shown in the tables 3 and 4, it may be therefore assumed that the impurities in the pores within the catalyst layers 12 has been sufficiently discharged outside the MEA 10 if the voltage change dV/dt at the end of the power generation process is 2.0 mV/h or less. From this result, it was confirmed that by making the voltage change dV/dt at the end of the power generation process to 2.0 mV/h or less, degradation that may be thereafter caused by the preservation can be controlled more effectively.

As should be appreciated from the fore going, in the preservation method of the polymer electrolyte membrane electrode assembly of the present invention, the power is output to the power load, i.e., the polymer electrolyte membrane electrode assembly 10 is caused to perform the power generation process while supplying the fuel gas to the anode catalyst layer 12 and the oxidizing gas to the cathode catalyst layer 12 before it is preserved for a long time period, thereby controlling degradation of the polymer electrolyte membrane electrode assembly 10 that may be thereafter caused by the preservation, and hence the voltage drop in the continued operation after the preservation. This may be due to the fact that water flow is formed between the anode side and the cathode side of the polymer electrolyte membrane electrode assembly 10, including pores of the catalyst layers 12, and has discharged away the solvent in the catalyst pores or the like which remain unvaporized during the polymer electrolyte membrane and electrode integration process, and the impurities such as metal invaded into the MEA 10 during the manufacture of the MEA.

In addition, with the preservation method of the polymer electrolyte membrane electrode assembly of the present invention, the fuel cell into which the polymer electrolyte membrane electrode assembly 10 has been incorporated is able to output a voltage stably, after being preserved. Furthermore, with the method, the polymer electrolyte membrane electrode assembly capable of maintaining the voltage drop performance that is equivalent to voltage drop performance during continued operation of the polymer electrolyte membrane electrode assembly just after the manufacture can be manufactured.

The preservation method of the polymer electrolyte membrane electrode assembly of the present invention is not intended to be limited to the power generation method described in the examples but may be easily altered in various ways without departing from the spirit of the invention.

Although the preferred embodiments of the invention have been discussed hereinabove, it is apparent that the invention is not necessarily limited to them. Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. Further, it should be noted that the details of the construction and/or functions of the invention may be modified within the scope of the invention.

### INDUSTRIAL APPLICABILITY

The preservation method of the polymer electrolyte membrane electrode assembly of the present invention is useful as the preservation method that controls degradation which may be caused by preservation, by causing the polymer electrolyte membrane electrode assembly to output a power to a power load while supplying a fuel gas to anode side of the assembly and an oxidizing gas to cathode side of the assembly, i.e., power generation process, before the assembly is preserved.

Furthermore, the preservation method of the polymer electrolyte membrane electrode assembly of the present invention is useful to the polymer electrolyte membrane electrode assembly of the fuel cell for use in home cogeneration systems, two-wheeled motor vehicles, electric vehicles, hybrid electric vehicles, home electric appliances, portable electric devices such as portable computers, cellular phones, portable acoustic instruments, personal digital assistances, and so forth which are required to output the voltage stably after the preservation.

1. A method of preserving a polymer electrolyte membrane electrode assembly including a polymer electrolyte membrane, a pair of catalyst layers disposed on both surfaces of the polymer electrolyte membrane, and a pair of gas diffusion electrodes disposed on outer surfaces of the pair of the catalyst layers, the method comprising the steps of:
causing the polymer electrolyte membrane electrode assembly to perform a power generation process just after the polymer electrolyte membrane electrode assembly is manufactured or within a time period in which the polymer electrolyte membrane electrode assembly is not degraded; and
thereafter preserving the polymer electrolyte membrane electrode assembly.

2. The method of preserving a polymer electrolyte membrane electrode assembly according to claim 1, wherein a current density in the power generation process is not less than 0.1 A/cm² and not more than 0.4 A/cm² per area of the catalyst layers.

3. The method of preserving a polymer electrolyte membrane electrode assembly according to claim 1, wherein the polymer electrolyte membrane electrode assembly is caused to perform the power generation process for 3 hours or more.

4. The method of preserving a polymer electrolyte membrane electrode assembly according to claim 1, wherein the polymer electrolyte membrane electrode assembly is caused to perform the power generation process until a voltage change becomes 2 mV/h or less.

5. The method of preserving a polymer electrolyte membrane electrode assembly according to claim 1, wherein the polymer electrolyte membrane electrode assembly is caused to perform the power generation process within 300 hours after the polymer electrolyte membrane electrode assembly is manufactured.

6. The method of preserving a polymer electrolyte membrane electrode assembly according to claim 1, wherein the polymer electrolyte membrane electrode assembly is caused to perform the power generation process while supplying a fuel gas and an oxidizing gas which have dew points within a range of not lower than −10° C. and not higher than +10° C. of a temperature of the polymer electrolyte membrane electrode assembly.
